(19) United States
(12) Patent Application Publication
(10) Pub. No.: US 2008/0303687 A1
(43) Pub. Date: Dec. 11, 2008

(54) Ambience Control

(75) Inventors: Adrianus Sempel, Eindhoven (NL); Cornelia Titia Staats, Eindhoven (NL); Joseph Franciscus Raymond Eijsermans, Eindhoven (NL); Peit Antonis, Eindhoven (NL); Onno Van Tertholen, Eindhoven (NL); Gerrit Jan Teije Huijgen, Eindhoven (NL); Lars Rene Chirstian Waumans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,633

(22) PCT Filed: Nov. 15, 2006
(86) PCT No.: PCT/IB2006/054264

§ 371 Date: May 22, 2008

(30) Foreign Application Priority Data
Nov. 25, 2005 (EP) 05111292.8

(51) Int. Cl. H05B 37/02

(52) U.S. Cl. 340/825

(57) ABSTRACT

A system 1 for controlling ambience of a designated environment comprises input means (3, 4-11) configured to receive at least one ambience input data, processing means (18) configured to process the at least one ambience input data in conjunction with a desired ambience profile for the designated environment, thereby generating at least one ambience output signal, and means (20) for providing said at least one ambience output signal to an ambience output unit, the unit being capable of generating a desired ambience corresponding to said ambience profile.

The present invention relates to a method for controlling ambience of a designated environment and to an apparatus for controlling ambience of a designated environment as well as a computer program for performing said method.

The ambience of the human environment affects the sense of well being, physical as well as mental, as well as factors related to this. Much effort has been put into controlling the environment, especially indoors, to thus create an ambience that resembles, e.g., outdoor lighting-conditions, since this is believed to affect the well being in a positive direction. This has resulted in products like for example fluorescent lighting having a color temperature resembling natural light. More complex control of lighting environment may involve color temperature control, and in WO03/024269 is described a grooming apparatus in which a user can vary the color temperature of white light generated by at least one light source including a plurality of LEDs.

A drawback with the devices and methods in prior art is that they represent solutions that are not very flexible, where a conventional light switch is replaced by some other means for controlling a lighting device.

Hence, a lack of flexibility and adaptability is considered to be an unfortunate limitation in the prior art devices and methods.

It is an object of the present invention to overcome or at least alleviate these drawbacks. This is achieved by way of providing a method for controlling ambience of a designated environment comprising the steps of:
obtaining at least one ambience input data,
process the at least one ambience input data in conjunction with a desired ambience profile for the designated environment, thereby generating at least one ambience output signal,
providing said at least one ambience output signal to an ambience output unit, the unit being capable of generating a desired ambience corresponding to said ambience profile.

The control method facilitates the creation of a tailor made ambience by using ambience input data, which can be static, e.g., in the sense that it comprises a preset dataset that is user made or user obtained, or dynamic, e.g., in the sense that it varies with variations in the environment. Further, the step of processing the ambience input data in conjunction with the desired ambience profile, which can comprise the so-called static ambience input data, facilitates a further enhancement of the desired ambience. The following generation of an ambience output signal is the final step of the method, making it possible to adjust, e.g., power and current properties to conform with standards of components in the ambience output unit, to which the output signal is sent, said output unit being capable of generating the desired ambience corresponding to the ambience profile.

According a preferred embodiment the at least one output signal comprises a first control information relating to a desired light ambience. Lighting is a major ambience affecter and the first control information can relate to several properties in the light emitted by the ambience output unit, such as intensity, color, spatial distribution and directivity. Since the ambience output unit can comprise several light sources this ensures total control over the desired ambience as will be further described in the detailed description.

To further enhance the experience of a certain ambience the output signal can also comprise control information relating to a desired sound ambiance. The resulting output from the ambience output unit also corresponds to the desired ambience profile.

The output signal can also comprise control information relating to a desired temperature ambience. This information, which also corresponds to the desired ambience profile, also facilitates a more qualitative experience of the desired ambience profile. The possibility of using temperature makes it possible to affect more of the human senses.

In a second aspect, the invention provides an apparatus for controlling ambience of a designated environment comprising,
input means configured to receive at least one ambience input data,
processing means configured to process the at least one ambience input data in conjunction with a desired ambience profile for the designated environment, thereby generating at least one ambience output signal,
means for providing said at least one ambience output signal to at least one ambience output unit, the at least one ambience output unit being capable of generating a desired ambience corresponding to said ambience profile.

Further, the invention relates to a computer program comprising software instructions that, when executed on a computer, performs a method as described above.

The invention will now be described in more detail with reference to the drawings on which:

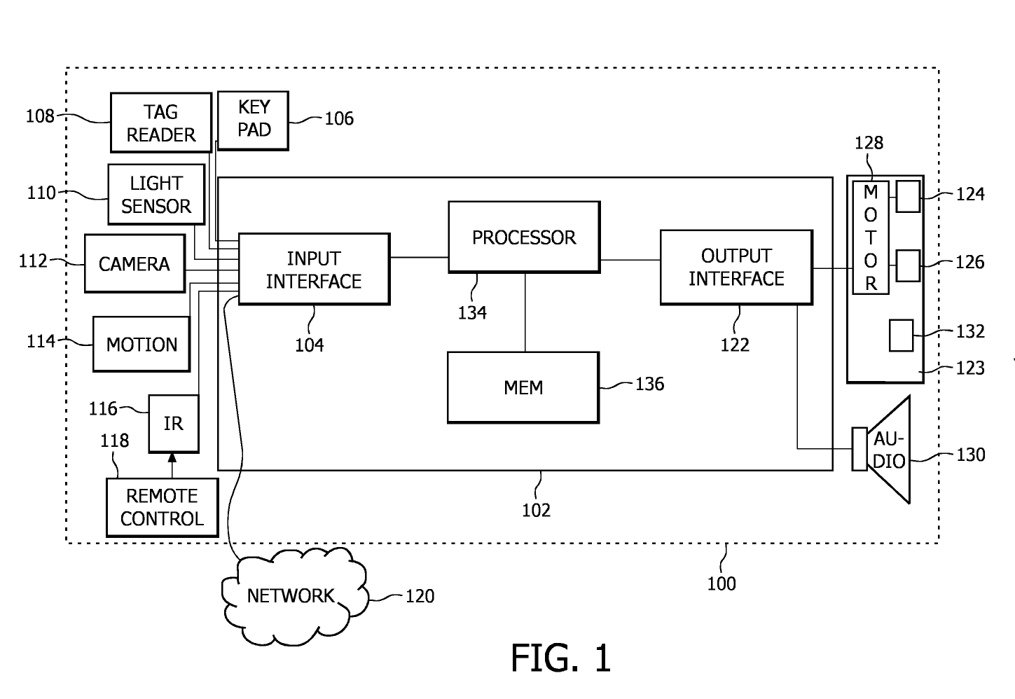

FIG. 1 is a block diagram illustrating a system in which the invention is realized.

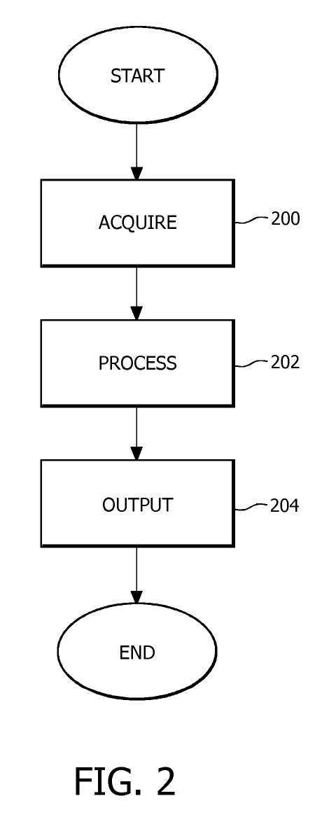

FIG. 2 is a flow chart of a method according to the present invention.

Referring to FIG. 1 a block diagram, illustrating a system 100 in which the invention is realized, is shown. In the following an example of the inventive system 100 will be described with the purpose of elucidating the capabilities and flexibility of the system, as a person skilled in the art will appreciate components can be added or removed without departing from the inventive concept.

The system 100 generally comprises ambience input units, ambience output units and a controller 102.

The ambience input units are connected to an input interface unit 104 in the controller 102. Examples of input units are: a keypad 106 able to communicate user input to the controller 102 via the input interface unit 104, a tag reader 108, e.g. a bar code reader or an RFID reader, a light sensor 110 comprising means for detecting an ambient light level, a camera 112 able to detect and communicate two-dimensional imaging information, a motion detector 114 able to detect changes in the physical environment, such as person entering the field of view of the detector, an IR-receiver 116 for detecting IR-information, e.g., from a remote control unit 118, and means for connection to a network 120, e.g., a local area network or the Internet.

Ambience output units are connected to an output interface unit 122 in the controller 102. Examples of output units are a lighting device 123 with light sources 124, 126 such as fluorescent TL tubes, HID lamps, LEDs etc. The lighting device 123 is spatially configured such that it is perceived as a window by a viewer. The light sources 124, 126 are able to generate light having various colors and brightness. The light sources 124, 126 may be further linked to a motor 128 which can vary the orientation of the light sources 124, 126. The output units further comprise an audio output device in the form of a loudspeaker 130 for providing audio signals, and a heater device in the form of a radiant heater 132 in order to enhance the impression of the light sources 124, 126.

The controller 102 comprises the input interface unit 104 mentioned above, a processor 134, a memory 136, the already mentioned output interface unit 122 comprising suitably configured driver circuitry (not shown) for the output units. The processor 134 controls the function of the units and the memory 136 contains data for use of the processor, including data that define any number of ambience profiles, which will be described in further detail below.

In typical operation the processor 134 analyses a desired user-selected ambience profile, stored in the memory 136, to select the input data needed for that particular profile. Next, the input data is acquired by use of the associated ambience input units through the ambience input interface unit 104, processed by the processor 134, which, after having processed the data in accordance with the desired ambience profile, controls the ambience output units via the output interface 122.

In other words, Referring to FIG. 2, an inventive method is described by way of a flowchart. An acquiring step 200 involves obtaining the ambience input data from the input data units, which is from readings of ambient conditions. In a following processing step 202 the ambience input data are processed in conjunction with a desired ambience profile for the designated environment, wherein the ambience output signal can be adequately generated. In an output step 204 the ambience output signal is provided to an ambience output unit, the unit being capable of generating a desired ambience corresponding to said ambience profile.

The desired ambience profile specifies a number of different parameters and conditions involving the parameters that are used by the processor in generating the output signals. These desired ambience profiles will now be exemplified in general terms to illustrate some various usages of the inventive system. Though general, the realization of the examples is considered to be obvious for a person skilled in the art, considering the previous description of the operation of the controller. For example, the skilled person will readily find suitable programming tools when realizing the processing in software instructions.

In a first ambience profile the processor 134 acquires information from the light-sensor 110 regarding the color of the sun and from the camera 112 regarding situation on a beach. The processor combines the acquired information with personal settings and the actual time of day and outputs sea-blue light at the bottom of the lighting device, sun-yellow light at the middle and a radiant blue-sky-light at the top. The registered data may be stored in the memory 136. Further the loudspeaker 130 is used to provide the sounds of water (rolling waves), people chatting on the beach, seagulls etc. The processor will then adjust the colors and sounds over time by using the input from the selected input units, the time of day, and the personal settings.

According to a second ambience profile, tailor-made for rainy days, the processor 134 acquires information from the camera 112 and the light-sensor 110 regarding the outside lighting ambience, and from the motion detector 114 regarding person's presence in the room. These input data are processed in conjunction with information stored in the memory 136 regarding the output profile for a sunny day. The processor 134 then combines the information and creates a merging output scene comprising a the sound of fading rain, a color change from rain-gray to sky-blue, taking about fifteen minutes. After about twenty minutes the color changes into a warm-white soothing color. The stated durations varies with the individual settings of profiles.

In a third ambience profile has the purpose of lengthening/stretching the day. In this profile the processor 134 mainly uses personal settings, such as start-time of working day, end-time of working day, latitude desired, desired music or sounds, climate as input data. The processor 134 then combines the input information with data stored in the memory regarding corresponding output and provides an output resembling a day, i.e., rising of the sun with its change in color temperature and position during the day, blue-sky light at the top of the lighting device, neutral light at the bottom and a varying heat radiation from the heater device 130.

A fourth ambience profile is activated as a result of a specific input, in this example an incoming signal from a mobile communication network. The processor 134 identifies the caller and visualizes simplified icon/scene on the ambience output device. Further input signals are, e.g., a picture from the callers phone. In a development of this embodiment a GSM phone can be incorporated in the system.

A fifth ambience profile is based on the same signal-activated profile but in this case the processor is triggered by a doorbell. As a result imaging information is acquired from a camera at the door, image processing takes place and a corresponding ambience output is delivered by the ambience output unit.

The final example of an ambience profile is directed towards an enhanced movie viewing experience. In this profile the processor gathers information regarding the color settings in a specific scene in a movie, or alternatively collects this information directly from a media-player output, and displays a similar color setting in the ambience output unit.

Although the exemplified embodiment uses a number of ambience input units and ambience output units it should be clear from the descriptions of the ambience profiles that not all of these units need to be used for all profiles. Further, the input signals could also comprise a fingerprint sensor, personalized codes for recognition and such and the ambience output unit could also comprise a smell-generator to further enhance the experience.

1. A method for controlling ambience of a designated environment comprising the steps of:
acquiring (200) at least one ambience input data,
processing (202) the at least one ambience input data in conjunction with a desired ambience profile for the designated environment, thereby generating at least one ambience output signal,
providing (204) said at least one ambience output signal to an ambience output unit, the unit being capable of generating a desired ambience corresponding to said ambience profile.

2. The method of claim 1, wherein the at least one output signal comprises a first control information relating to a desired light ambience.

3. The method of claim 2, wherein the light ambiance relates to light intensity.

4. The method of claim 2, wherein the light ambiance relates to color.

5. The method of claim 2, wherein the light ambiance relates to spatial distribution of light.

6. The method of claim 2, wherein the light ambiance relates to directivity of light.

7. The method of claim 1, wherein the at least one output signal also comprises control information relating to a desired sound ambience.

8. The method of claim 1, wherein the at least one output signal comprises control information relating to a desired temperature ambience.

9. The method of claim 1, wherein the step of acquiring input data involves reading a signal from a sensor.

10. The method of claim 9, wherein the reading of the signal involves reading a signal from any one of: a keypad (106), a tag reader (108), a light sensor (110) a camera (112), a motion detector (114), an IR receiver (116), a remote control unit (118) and a network (120), or any combination of these.

11. An apparatus (100) for controlling ambience of a designated environment comprising,
input means (104) configured to receive at least one ambience input data,
processing means (134,136) configured to process the at least one ambience input data in conjunction with a desired ambience profile for the designated environment, thereby generating at least one ambience output signal,
means (122) for providing said at least one ambience output signal to at least one ambience output unit (123,130), the at least one ambience output unit being capable of generating a desired ambience corresponding to said ambience profile.

12. A computer program comprising software instructions that, when executed in a computer, performs a method according to claim 1.
